(19) United States
(12) Patent Application Publication
(10) Pub. No.: US 2012/0054036 A1
(43) Pub. Date: Mar. 1, 2012

(54) INTERNET TELEMATICS SERVICE PROVIDING SYSTEM AND INTERNET TELEMATICS SERVICE PROVIDING METHOD FOR VEHICLE MAINTENANCE

(75) Inventors: Kyung Bo NAM, Seongnam-si (KR); Choong Hee LEE, Seongnam-si (KR)

(73) Assignee: NHN CORPORATION, Seongnam-si (KR)

(21) Appl. No.: 13/215,630

(22) Filed: Aug. 23, 2011

(30) Foreign Application Priority Data
Aug. 24, 2010 (KR) 10-2010-0081961

(51) Int. Cl. G06F 17/00; G06F 17/30; G06Q 30/00

(52) U.S. Cl. 705/14.64; 707/706; 707/E17.108; 701/31.4

(57) ABSTRACT

The present invention is related to an Internet telematics service providing system and method that may manage a state of a vehicle using an Internet/Web service and may provide various types of vehicle information. The Internet telematics service providing system may include a receiver to receive vehicle event information from a telematics system of the vehicle, a storage unit to store the vehicle event information on a webpage associated with the user, and a providing unit to provide the vehicle event information to the communication terminal using an Internet/Web service.

### CROSS REFERENCE TO RELATED APPLICATION

This application claims priority from and the benefit of Korean Patent Application No. 10-2010-0081961, filed on Aug. 24, 2010, which is hereby incorporated by reference for all purposes as if fully set forth herein.

### BACKGROUND OF THE INVENTION

1. Field of the Invention

Exemplary embodiments of the present invention relate to an Internet telematics service providing system and a method that may manage a state of a vehicle using an Internet service and may provide vehicle information.

2. Discussion of the Background

Recently, there have been active developments in telematics technology for providing various services, for example, an automatic accident report, an emergency service call, and a guide service to a driver via a terminal installed in a vehicle by integrally employing a mobile communication technology, a satellite positioning technology, a map information technology, and/or a vehicle control technology. The telematics technology may provide a more convenient and safe driving environment and an environment in which the driver may use information services in the vehicle without interruption.

There is, however, a need for an enhanced system and method for providing information to a driver of a vehicle using various Internet services.

### SUMMARY OF THE INVENTION

Exemplary embodiments of the present invention provide an Internet telematics service providing system and method that may provide enhanced user convenience by providing vehicle event information and additional functions that enable a user to manage a state of a vehicle using an Internet service.

Additional features of the invention will be set forth in the description which follows, and in part will be apparent from the description, or may be learned by practice of the invention.

Exemplary embodiments of the present invention disclose a system for providing a telematics service, the system includes a receiver, a storage unit, and a providing unit. The receiver receives vehicle event information from a telematics system. The storage unit stores the vehicle event information. The providing unit provides the vehicle event information to the communication terminal via a wireless network.

Exemplary embodiments of the present invention also disclose a method of providing a telematics service. The method includes receiving vehicle event information from a telematics system, storing the vehicle event information, and providing the vehicle event information to the communication terminal via a wireless network.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a block diagram of a telematics system, a communication terminal, and an Internet telematics service providing system according to exemplary embodiments of the present invention.

FIG. 2 is a block diagram of a configuration of an Internet telematics service providing system providing vehicle event information to a user according to exemplary embodiments of the present invention.

FIG. 3 is a block diagram of a configuration of a storage unit to store vehicle event information in an Internet telematics service providing system according to exemplary embodiments of the present invention.

FIG. 4 is a view of a webpage displaying vehicle event information according to exemplary embodiments of the present invention.

FIG. 5 is a block diagram of an additional configuration of an Internet telematics service providing system for providing a search result including Internet information associated with vehicle event information according to exemplary embodiments of the present invention.

FIG. 6 is a block diagram of an additional configuration of an Internet telematics service providing system for providing advertising information associated with vehicle event information according to exemplary embodiments of the present invention.

FIG. 7 is a flowchart of an Internet telematics service providing method for providing vehicle event information to a user according to exemplary embodiments of the present invention.

FIG. 8 is a flowchart of an Internet telematics service providing method for providing a search result including Internet information associated with vehicle event information according to exemplary embodiments of the present invention.

FIG. 9 is a flowchart of an Internet telematics service providing method for providing advertising information associated with vehicle event information according to exemplary embodiments of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element is referred to as being “on” or “connected to” another element, it can be directly connected to the other element, or intervening elements may be present. In contrast, when an element is referred to as being “directly on” or directly connected to” another element or layer, there are no intervening elements or layers present. It may also be understood that for the purposes of this disclosure, “at least one of X, Y, and Z” can be construed as X only, Y only, Z only, or any combination of two or more items X, Y, and Z (e.g., XYZ, XYY, YZ, ZZ).

Hereinafter, exemplary embodiments of the present invention will be described in detail with reference to the accompanying drawings.

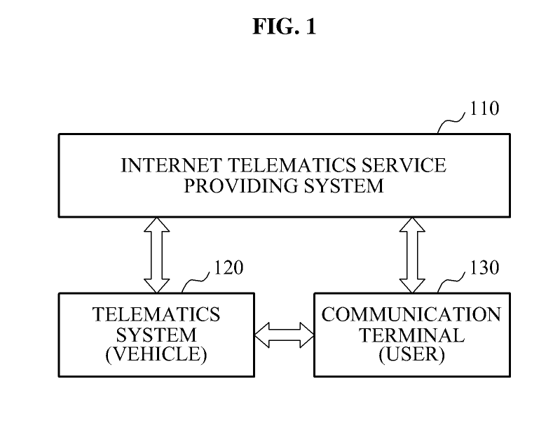

FIG. 1 is a block diagram of a telematics system 120, a communication terminal 130, and an Internet telematics service providing system 110 according to exemplary embodiments of the present invention. Referring to FIG. 1, the telematics system 120 of a vehicle and/or the communication terminal 130 used by a user may interact with the Internet telematics service providing system 110.

The Internet telematics service providing system 110 may provide a user with an Internet/Web service so that the user may verify and manage a state of a vehicle while interacting with the telematics system 120 and/or the communication terminal 130. The Internet telematics service providing system 110 may store vehicle event information on a webpage and may provide the vehicle event information to the communication terminal 130 using the Internet service. The Internet telematics service providing system 110 may also provide a search result including information associated with the vehicle event information or advertising information associated with the vehicle event information to the telematics system 120 and/or the communication terminal 130 in real time.

The telematics system 120 may be, for example, a navigation terminal in the vehicle, and may communicate with the Internet telematics service providing system 110 and/or the communication terminal 130 over a wireless data network. In general, the telematics system 120 may be any electronic device that can communicate with the Internet telematics service providing system 110 and/or the communication terminal 130 in any suitable manner.

The communication terminal 130 may be any suitable mobile device including, for example, a portable personal computer (PC) or a mobile phone, and may communicate with the Internet telematics service providing system 110 and/or the telematics system 120 over any suitable wireless data network. Examples of a wireless data network include, but are not limited to, wireless wide area networks (WANs), wireless metropolitan area networks (WMANs), wireless mesh networks, Worldwide Interoperability for Microwave Access (WiMAX), cellular networks, and other broadband wireless microwave and radio frequency networks.

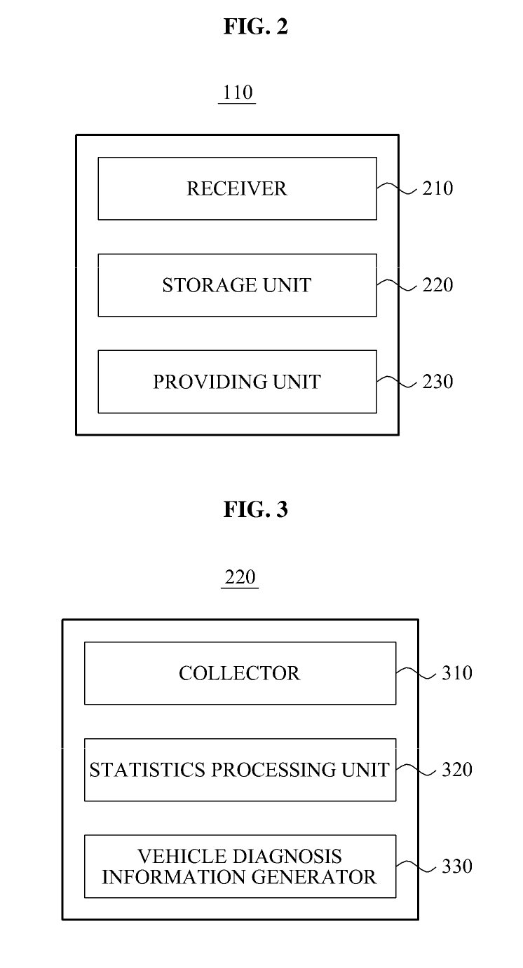

FIG. 2 is a block diagram illustrating a configuration of an Internet telematics service providing system 110 providing vehicle event information to a user according to exemplary embodiments of the present invention. Referring to FIG. 2, the Internet telematics service providing system 110 may include a receiver 210, a storage unit 220, and a providing unit 230.

The receiver 210 may receive vehicle event information occurring in the vehicle from the telematics system 120. The telematics system 120 may detect events occurring in the vehicle, such as, for example, fueling, replacement of consumable supplies (e.g., engine oil, brake fluid), malfunctions in the engine or vehicle parts, and may provide corresponding vehicle event information to receiver 210. The telematics system 120 may detect the events directly (e.g., by itself using various suitable detection mechanisms) or may receive the vehicle event information from the vehicle. The vehicle event information may include at least one of fuel-related information including a fuel cycle and a fuel amount with respect to a fueling event, consumable supply replacement-related information including a type of a consumable supply to be replaced and a replacement cycle of the consumable supply with respect to a consumable supply replacement event, and malfunction-related information including a malfunction code and a malfunction description according to occurrence of a malfunction event.

The storage unit 220 may store the vehicle event information on a webpage associated with the user (e.g., driver of the vehicle), a user database, a storage medium, and/or, in general, any suitable computer-readable media. The webpage associated with the user may be a page allocated to the user. The webpage may be a page associated with the vehicle and thus, may include a page or link to an Internet/Web community site associated with the vehicle. For example, the page may be a blog or a café.

Suitable computer-readable media may include, but are not limited to, transitory and non-transitory media, and volatile and non-volatile memory. The computer-readable media may include storage media, such as, for example, read-only memory (ROM), random access memory (RAM), floppy disk, hard disk, optical reading media (e.g., compact disc-read-only memory (CD-ROM), digital versatile discs (DVDs), hybrid magnetic optical disks, organic disks, flash memory drives or any other volatile or non-volatile memory, and other semiconductor media. The computer-readable storage media can store and execute computer-readable codes that are distributed in computers connected via a network. The computer-readable media also includes cooperating or interconnected computer-readable media that are in the processing system or are distributed among multiple processing systems that maybe local or remote to the processing system. The computer readable medium or media can be transportable, such that the program or programs stored thereon can be loaded onto one or more different computers or other processors to implement various aspects of the present invention as discussed herein.

The providing unit 230 may provide the vehicle event information to the communication terminal 130 using an Internet/Web service. For example, the providing unit 230 may provide, to the communication terminal 130, the webpage storing vehicle event information using the Internet/Web service so that the user may remotely verify and/or manage the vehicle in real time. The providing unit 230 may provide a vehicle book keeping service to the communication terminal 130 using the Web/Internet service based on vehicle event information stored on the webpage. Fuel information, the consumable supply replacement information and/or malfunction information, as described hereinabove, may be provided by the providing unit 230 to the communication terminal 130 using an Internet/Web service so that a user of the communication terminal 130 can be informed of the state of a vehicle in which the telematics system 120 is located in. The providing unit 230 may also provide the vehicle event information to a vehicle manufacturing company server (not shown) of the manufacturer of the vehicle to verify the vehicle event information so that a vehicle manufacturer may quickly and professionally be informed and manage events associated with the vehicle of the user.

FIG. 3 is a block diagram of the storage unit 220 to store vehicle event information in an Internet telematics service providing system 110 according to exemplary embodiments of the present invention. The storage unit 220 may include a collector 310, a statistics processing unit 320, and a vehicle diagnosis information generator 330.

The collector 310 may classify and collect vehicle event information for each event. For example, the collector 310 may determine information regarding a fueling cycle and a fuel amount with respect to a fueling event, determine information regarding a consumable supply to be replaced and a replacement cycle with respect to a consumable supply replacement event, and determine information regarding a malfunction code and a malfunction description with respect to a malfunction event. In some cases, the vehicle event information may be accumulatively stored for each vehicle event and thus, various types of modification made with respect to the vehicle may be automatically stored on the webpage.

The statistics processing unit 320 may perform statistical processing of the collected vehicle event information and generate statistical information. For example, the statistics processing unit 320 may generate statistical information about the fueling cycle and the fueling amount by processing fueling-related information that may have been accumulated according to fueling event(s), or may compute statistical information about a replacement cycle for each consumable supply by processing consumable supply-related information that is accumulated according to consumable supply replacement event(s).

The vehicle diagnosis information generator 330 may generate vehicle diagnosis information based on the statistical information. For example, the vehicle diagnosis information generator 330 may determine a fueling cycle based on statistical information associated with the fueling cycle and the fueling amount, and/or may determine a replacement cycle for each consumable supply based on statistical information associated with the consumable supply replacement information.

The storage unit 220 may store vehicle diagnosis information that is generated by the vehicle diagnosis information generator 330 from the vehicle event information. The providing unit 230 may provide the stored vehicle diagnosis information to the communication terminal 130 using the Internet/Web service.

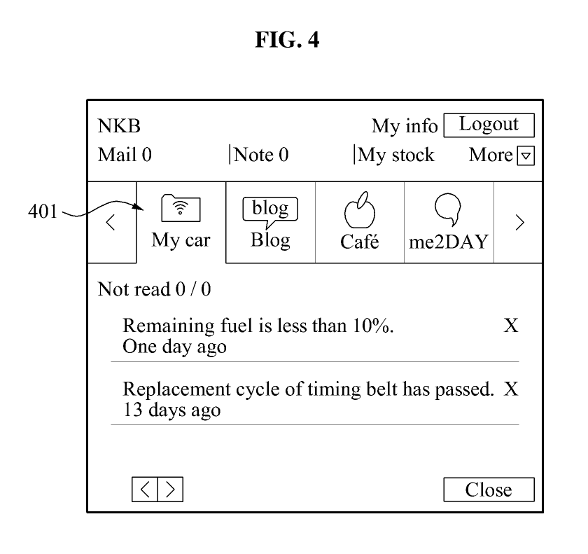

FIG. 4 is a view of a webpage displaying vehicle event information according to exemplary embodiments of the present invention. Referring to FIG. 4, the providing unit 230 may display, on the communication terminal 130 using an Internet/Web service, a webpage 401 that displays vehicle event information and/or vehicle diagnosis information generated from the vehicle event information. The Internet telematics service providing system 110 may provide the user with information on a fueling cycle and/or a consumable supply replacement cycle using the communication terminal 130. Accordingly, a user/driver of the vehicle may be informed of the state of the vehicle and/or any problems with the vehicle in real time. For example, the providing unit 230 may generate a message including vehicle diagnosis information such as the fueling cycle and/or a replacement cycle for each consumable supply, and may transmit the message to the communication terminal 130. The providing unit 230 may also generate the vehicle diagnosis information using a popup window that may be provided along with the webpage, and may display the popup window on the communication terminal 130. The providing unit 230 may also provide the vehicle diagnosis information to a vehicle manufacturing company server (not shown) of the manufacturer of the vehicle.

The storage unit 220 may also collect vehicle event information and/or vehicle diagnosis information of multiple users in association with an Internet information providing server (not shown) and may generate a comparison result of data between the two users and may store the comparison result. The providing unit 230 may provide the comparison result to the communication terminal 130 using the Internet/Web service.

The storage unit 220 may store expense information according to a fueling event based on fuel station information that may be determined based on position information of the vehicle and fuel price information. The fuel price information may be determined based on fuel station information and a fuel amount. For example, the storage unit 220 may determine a fuel price charged by a fuel station that is situated within a predetermined radius of the vehicle using Global Positioning System (GPS) information of the vehicle, and may generate expense information according to an expected fuel amount and a corresponding fuel price. The storage unit 220 may then store the expense information and may provide the expense information to the user via a webpage. The providing unit 230 may provide a vehicle book keeping service to the communication terminal 130 based on the expense information. The predetermined radius may be set by the user of the communication terminal 130 or by a manufacturer of the internet telematics service providing system 110. The expected fuel amount may be the amount of fuel needed to fill the fuel tank to a determined level, such as, a level corresponding to a filled fuel tank. The determined level of the fuel tank may be set by the user of the communication terminal 130 or the driver of the vehicle in which the telematics system 120 is located in. The book keeping service may record the expected fuel amount (and corresponding price) and the actual filled fuel amount (and corresponding price) upon the next visit to the fuel station. Information used and provided by the book keeping service may be stored in the storage unit 220.

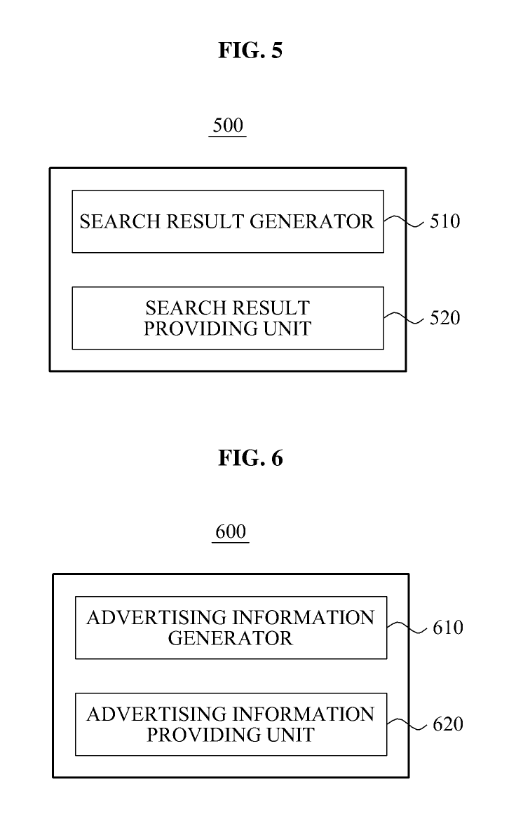

FIG. 5 is a block diagram of an additional configuration of an Internet telematics service providing system 500 for providing a search result including Internet information associated with vehicle event information according to exemplary embodiments of the present invention. The Internet telematics service providing system 500 may correspond to the Internet telematics service providing system 110 of FIG. 2, and may further include a search result generator 510 and a search result providing unit 520.

The search result generator 510 may generate a search result including Internet information associated with the vehicle diagnosis information by using an Internet information search server (not shown) that may execute searches on the Internet. For example, the search result generator 510 may generate a keyword based on the vehicle diagnosis information, and may extract Internet information corresponding to the keyword from the Internet information search server. The search result generator 510 may automatically search for the Internet information associated with the vehicle diagnosis information, and may generate the search result based on the Internet information. For example, when the vehicle diagnosis information corresponds to a fueling cycle, the search result generator 510 may generate the search result including at least one of fuel station information corresponding to fuel stations within a predetermined radius of the current position of the vehicle, fuel price information for each fuel station within the predetermined radius of the current position of the vehicle, and an Internet search query and response information for each of the fuel stations within the predetermined radius of the current position of the vehicle. The predetermined radius may be set by the user of the communication terminal 130 or by a manufacturer of the internet telematics service providing system 110.

When the vehicle diagnosis information corresponds to a consumable supply replacement cycle, the search result generator 510 may generate a search result including at least one of vehicle garage information associated with a vehicle garage within a predetermined radius of the current position of the vehicle, information about each part of the vehicle to be replaced, and an Internet query and question information for each part of the vehicle to be replaced. The predetermined radius may be set by the user of the communication terminal 130 or by a manufacturer of the internet telematics service providing system 110. A vehicle garage may be any business or operator that repairs and/or manufactures vehicles, or may be a business or operator that supplies automobile parts.

When the vehicle diagnosis information corresponds to a malfunction, the search result generator 510 may generate a search result including at least one of vehicle garage information associated with a vehicle garage within a predetermined radius of the current position of the vehicle, and/or an Internet query and related questions for the malfunction. The predetermined radius may be set by the user of the communication terminal 130 or by a manufacturer of the internet telematics service providing system 110.

The search result providing unit 520 may provide a search result to the telematics system 120 and/or the communication terminal 130. The search result providing unit 520 may store the search result associated with the vehicle diagnosis information on the webpage associated with the user, and may transfer the search result to the user via the telematics system 120 and/or the communication terminal 130.

Accordingly, when a fuel amount remaining in the vehicle is less than a predetermined quantity set by the vehicle manufacturer or the user, when an engine oil replacement is due, or when a malfunction is detected in the vehicle, the Internet telematics service providing system 500 may immediately transfer, to the user, via the telematics system 120 and/or the communication terminal 130, a corresponding Internet query and response information, shopping information, and price information. The Internet telematics service providing unit 500 may also provide information about a fuel station or a vehicle garage in proximity of the vehicle, a current position of the user, a residential address of the user, and/or, in general, any location specified by the user.

FIG. 6 is a block diagram of an additional configuration of an Internet telematics service providing system 600 for providing advertising information associated with the vehicle event information according to exemplary embodiments of the present invention. The Internet telematics service providing system 600 may correspond to the Internet telematics service providing system 110, and may also include an advertising information generator 610 and an advertising information providing unit 620.

The advertising information generator 610 may generate advertising information associated with the vehicle diagnosis information by communicating with an advertising server (not shown). The advertising information may include link information providing at least one of a vehicle insurance company advertisement/website, a fuel company's advertisement/website, and a vehicle maintenance company advertisement/website. The advertising information generator 610 may extract an advertisement corresponding to vehicle diagnosis information associated with a vehicle fueling, replacement of consumable supplies, and/or a malfunction occurrence based on the vehicle diagnosis information. For example, the advertising information generator 610 may generate a keyword based on the vehicle diagnosis information, and may extract, from the advertisement server, an advertisement corresponding to the keyword.

The advertising information providing unit 620 may provide the advertising information to the telematics system 120 and/or the communication terminal 130. The advertising information providing unit 620 may provide an advertisement associated with the vehicle diagnosis information, using the advertising information, to the telematics system 120 and/or the communication terminal 130.

Accordingly, the Internet telematics service providing system 600 may provide, to the user via the telematics system 120 and/or the communication terminal 130, the advertisement associated with the vehicle diagnosis information, such as an advertisement related to vehicle refueling, a consumable supply replacement, or a malfunction. Accordingly, an advertiser may provide an advertisement that is directly associated with the vehicle diagnosis information when required by the user, thereby enhancing advertising effect and efficiency.

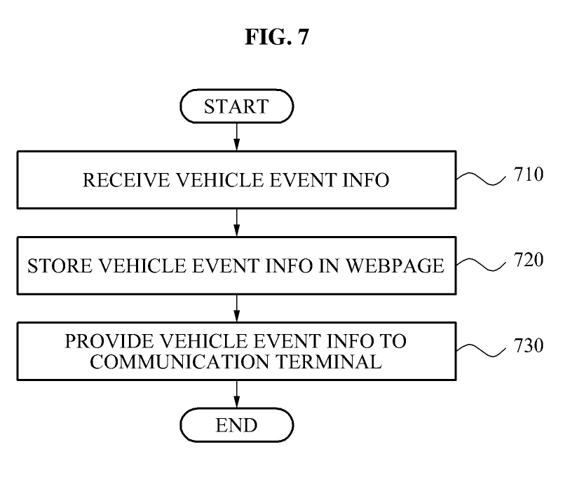

FIG. 7 is a flowchart of an Internet telematics service providing method for providing vehicle event information to a user according to exemplary embodiments of the present invention. The Internet telematics service providing method may be performed by the Internet telematics service providing system 110.

In 710, the Internet telematics service providing system 110 may receive vehicle event information from the telematics system 120. The vehicle event information may include at least one of fuel-related information including information associated with a fuel cycle and a fuel amount with respect to a fueling event, consumable supply replacement-related information including information associated with a consumable supply to be replaced and a replacement cycle of the consumable supply with respect to a consumable supply replacement event, and malfunction-related information including information associated with a malfunction code and a malfunction description with respect to a malfunction event.

In 720, the Internet telematics service providing system 110 may store the vehicle event information on a webpage associated with the user (e.g., driver of the vehicle), a user database, a storage medium, and/or, in general, any suitable computer-readable media. The webpage associated with the user may be a page allocated to the user. The webpage may be a page associated with the vehicle and thus, may indicate a page or link to an Internet/Web community site associated with the vehicle. For example, the page may be a blog or a café.

Suitable computer-readable media may include, but are not limited to, transitory and non-transitory media, and volatile and non-volatile memory. The computer-readable media may include storage media, such as, for example, read-only memory (ROM), random access memory (RAM), floppy disk, hard disk, optical reading media (e.g., compact disc-read-only memory (CD-ROM), digital versatile discs (DVDs), hybrid magnetic optical disks, organic disks, flash memory drives or any other volatile or non-volatile memory, and other semiconductor media. The computer-readable storage media can store and execute computer-readable codes that are distributed in computers connected via a network. The computer-readable media also includes cooperating or interconnected computer-readable media that are in the processing system or are distributed among multiple processing systems that maybe local or remote to the processing system. The computer readable medium or media can be transportable, such that the program or programs stored thereon can be loaded onto one or more different computers or other processors to implement various aspects of the present invention as discussed herein.

In 730, the Internet telematics service providing system 110 may provide the vehicle event information to the communication terminal 130 using an Internet/Web service. The Internet telematics service providing system 110 may provide, to the communication terminal 130, the webpage storing the vehicle event information via the Internet/Web service so that the user may remotely verify or manage the state of the vehicle in real time. For example, the Internet telematics service providing system 110 may provide a vehicle book keeping service to the communication terminal 130 using the Internet/Web service based on the vehicle event information on the webpage. Fuel information, consumable supply replacement information, and/or malfunction information of a vehicle may be provided by the providing unit 230 to the communication terminal 130 using the Internet/Web service so that a user of the communication terminal 130 can be informed of the state of a vehicle in which the telematics system 120 is located in. In addition, the Internet telematics service providing system 110 may provide the vehicle event information to a vehicle manufacturing companying server (not shown) of the manufacturer of the vehicle so that the vehicle manufacturer may verify the vehicle-related information based on the vehicle event information and so that the vehicle manufacturer may quickly and professionally be informed and manage events associated with the vehicle of the user.

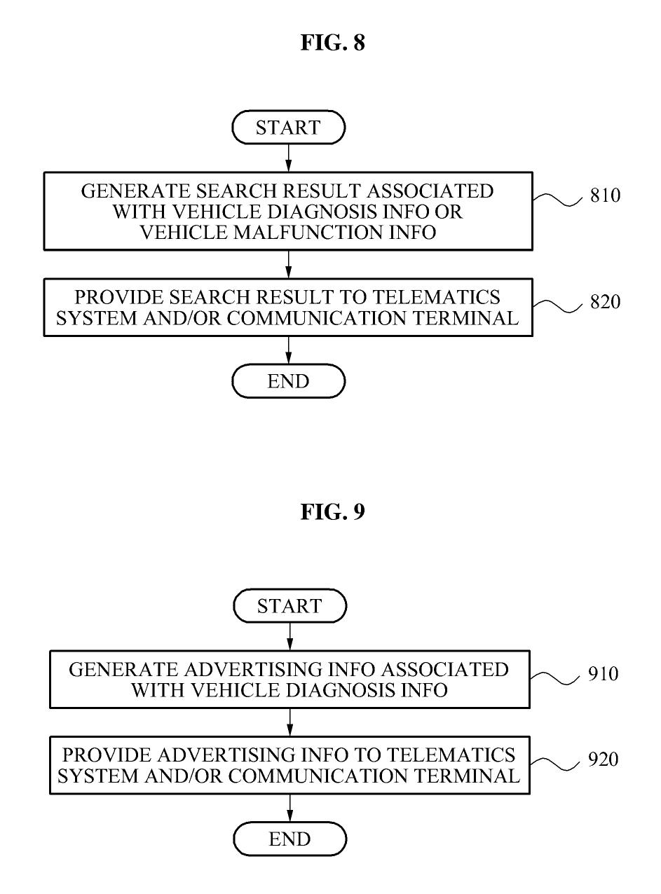

FIG. 8 is a flowchart illustrating an Internet telematics service providing method for providing a search result including Internet information associated with vehicle event information according to exemplary embodiments of the present invention. The Internet telematics service providing method may be performed by the Internet telematics service providing system 500 of FIG. 5.

In 810, the Internet telematics service providing system 500 may generate a search result including Internet information associated with the vehicle diagnosis information by using an Internet information search server (not shown) that searches the Internet for information. For example, the Internet telematics service providing system 500 may generate a keyword based on vehicle diagnosis information and may extract Internet information corresponding to the keyword from the Internet information search server. The Internet telematics service providing system 500 may automatically search for Internet information associated with the vehicle diagnosis information and may generate the search result based on the Internet information. For example, when the vehicle diagnosis information corresponds to a fueling cycle, the Internet telematics service providing system 500 may generate the search result including at least one of fuel station information corresponding to fuel stations within a predetermined radius of a current position of the vehicle, fuel price information for each fuel station within the predetermined radius of the current position of the vehicle, and an Internet search query and response information for each of the fuel stations within the predetermined radius of the current position of the vehicle. The predetermined radius may be set by the user of the communication terminal 130 or by a manufacturer of the internet telematics service providing system 110.

When the vehicle diagnosis information corresponds to a consumable supply replacement cycle, the Internet telematics service providing system 500 may generate a search result including at least one of vehicle garage information associated with a vehicle garage located within a predetermined radius of the current position of the vehicle, information (e.g., price, technical details) about each part of the vehicle to be replaced, Internet search query and information for each part to be replaced. The predetermined radius may be set by the user of the communication terminal 130 or by a manufacturer of the internet telematics service providing system 110.

When the vehicle diagnosis information corresponds to a vehicle malfunction, the Internet telematics service providing system 500 may generate a search result including at least one of vehicle garage information associated with a vehicle garage within a predetermined radius of the current position of the vehicle, and an Internet query and related questions information for the malfunction. The predetermined radius may be set by the user of the communication terminal 130 or by a manufacturer of the internet telematics service providing system 110. A vehicle garage may be any business or operator that repairs and/or manufactures vehicles, or may be a business or operator that supplies automobile parts.

In 820, the Internet telematics service providing system 500 may provide the search result to the telematics system 120 and/or the communication terminal 130. The Internet telematics service providing system 500 may store the search result associated with vehicle diagnosis information on the webpage associated with the user, and may transfer the search result to the user via the telematics system 120 and/or the communication terminal 130. For example, when a fuel amount remaining in the vehicle is less than a predetermined quantity set by the vehicle manufacturer or the user, when an engine oil replacement cycle is due, or when a malfunction is detected in the vehicle, the Internet telematics service providing system 500 may immediately transfer, to the user via the telematics system 120 and/or the communication terminal 130, a corresponding Internet query and response information, shopping information and/or price information. The Internet telematics service providing unit 500 may also provide, based on the vehicle diagnosis information, information about a fuel station or a repair garage in proximity of the vehicle, a current position of the user, a residential address of the user, and/or, in general, any location specified by the user.

FIG. 9 is a flowchart of an Internet telematics service providing method for providing advertising information associated with vehicle event information according to exemplary embodiments of the present invention. The Internet telematics service providing method may be performed by the Internet telematics service providing system 600 of FIG. 6.

In 910, the Internet telematics service providing system 600 may generate advertising information associated with the vehicle diagnosis information by communicating with an advertising server (not shown). The advertising information may include link information providing at least one of a vehicle insurance company advertisement/website, a fuel company's advertisement/website, and a maintenance company advertisement/website. The Internet telematics service providing system 600 may extract an advertisement corresponding to vehicle diagnosis information associated with a vehicle fueling, replacement of consumable supplies, and/or a malfunction occurrence based on the vehicle diagnosis information. For example, the Internet telematics service providing system 600 may generate a keyword based on the vehicle diagnosis information, and may extract, from the advertisement server, an advertisement corresponding to the keyword.

In 920, the Internet telematics service providing system 600 may provide the advertising information to the telematics system 120 and/or the communication terminal 130. The Internet telematics service providing system 600 may provide an advertisement associated with the vehicle diagnosis information using the advertising information to the telematics system 120 and/or the communication terminal 130. For example, the Internet telematics service providing system 600 may provide, to the user, via the telematics system 120 and/or the communication terminal 130, the advertisement associated with the vehicle diagnosis information, such as an advertisement related to vehicle refueling, a consumable supply replacement cycle, and/or a malfunction occurrence. Accordingly, an advertiser may provide an advertisement that is directly associated with the vehicle diagnosis information when required by the user, thereby enhancing advertising effect and efficiency.

According to exemplary embodiments of the present invention, it may be possible to provide various types of information, help, and/or suggestions associated with a vehicle to a user at all times by providing a function that enables the user to verify and manage a state of the vehicle via an Internet/Web service using a telematics system of the vehicle (e.g., a navigation system) and a communication terminal of the user. It is also possible to provide a solution and information regarding a malfunction in the vehicle to the user by automatically searching for Internet information associated with the malfunction.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A system to provide a telematics service, the system comprising:
a receiver to receive vehicle event information from a telematics system;
a storage unit to store the vehicle event information; and
a providing unit to provide the vehicle event information to a communication terminal via a wireless network.

2. The system of claim 1, wherein the storage unit comprises:
a collector to classify the stored vehicle event information;
a statistical processing unit to perform statistical processing of the collected vehicle event information and to generate statistical information according to the statistical processing; and
a vehicle diagnosis information generator to generate vehicle diagnosis information based on the statistical information, and
wherein the providing unit provides the vehicle diagnosis information to the communication terminal via the wireless network.

3. The system of claim 2, further comprising:
a search result generator to generate, via an Internet information search server, a search result comprising information associated with the vehicle diagnosis information; and
a search result providing unit to provide the search result to at least one of the telematics system and the communication terminal.

4. The system of claim 3, wherein the search result comprises at least one of vehicle garage information and query and response information associated with the vehicle diagnosis information.

5. The system of claim 2, further comprising:
an advertising information generator to generate, via an advertising server, advertising information associated with the vehicle diagnosis information; and
an advertising information providing unit to provide the advertising information to at least one of the telematics system and the communication terminal.

6. The system of claim 5, wherein the advertising information comprises information associated with at least one of a vehicle insurance company advertisement, a fuel company advertisement, and a maintenance company advertisement.

7. The system of claim 1, further comprising:
a search result generator to generate, via an Internet information search server, a search result comprising search information associated with a vehicle malfunction in response to receiving the vehicle event information due to the vehicle malfunction; and
a search result providing unit to provide the search result to at least one of the telematics system and the communication terminal.

8. The system of claim 7, wherein the search result comprises vehicle garage information or fuel station information based on a location of the vehicle.

9. The system of claim 7, wherein the search result comprises Internet query and response information associated with the vehicle malfunction.

10. The system of claim 1, wherein the providing unit further provides the vehicle event information to a vehicle manufacturing company server of a manufacturer of the vehicle.

11. The system of claim 1, wherein the vehicle event information comprises at least one of fueling-related information, consumable supply replacement-related information, and malfunction-related information, the fueling-related information comprising information on at least one of a fuel cycle and a fuel amount with respect to a fueling event, the consumable supply replacement-related information comprising information on at least one of a consumable supply to be replaced and a replacement cycle, and the malfunction-related information comprising information on at least one of a malfunction code and a malfunction description.

12. The system of claim 11, wherein in response to receiving the vehicle event information corresponding to the fueling-related information, providing expense information and fuel price information via a webpage according to the fueling event, a fuel station located within a determined distance of the vehicle, and the fuel amount verified from fuel station information corresponding to the fuel station, and
wherein the providing unit provides a vehicle book keeping service to the communication terminal based on the expense information.

13. A method of providing a telematics service, the method comprising:
receiving vehicle event information from a telematics system;
storing the vehicle event information; and
providing the vehicle event information to the communication terminal via a wireless network.

14. The method of claim 13, wherein the storing vehicle event information comprises:
classifying the stored vehicle event information;
performing statistical processing of the collected vehicle event information to generate statistical information; and
generating vehicle diagnosis information based on the statistical information, and
wherein the providing unit comprises providing the vehicle diagnosis information to the communication terminal via the wireless network.

15. The method of claim 14, further comprising:
generating, via an Internet information search server, a search result comprising information associated with the vehicle diagnosis information; and
providing the search result to at least one of the telematics system and the communication terminal.

16. The method of claim 15, wherein the search result comprises at least one of vehicle garage information and query and response information associated with the vehicle diagnosis information.

17. The method of claim 14, further comprising:
generating, via an advertising server, advertising information associated with the vehicle diagnosis information; and
providing the advertising information to at least one of the telematics system and the communication terminal.

18. The method of claim 17, wherein the advertising information comprises information associated with at least one of a vehicle insurance company advertisement, a fuel company advertisement, and a maintenance company advertisement.

19. The method of claim 13, further comprising:
generating, via an Internet information search server, a search result comprising information associated with a vehicle malfunction in response to receiving the vehicle event information due to the vehicle malfunction; and
providing the search result to at least one of the telematics system and the communication terminal.

20. The method of claim 19, wherein the search result comprises vehicle garage information or fuel station information based on a location of the vehicle.

21. The method of claim 19, wherein the search result comprises query and response information associated with the vehicle malfunction.

22. The method of claim 13, wherein the providing comprises providing the vehicle event information to a vehicle manufacturing company server of a manufacturer of the vehicle.

23. The method of claim 13, wherein the vehicle event information comprises at least one of fueling-related information, consumable supply replacement-related information, and malfunction-related information, the fueling-related information comprising information on at least one of a fuel cycle and a fuel amount with respect to a fueling event, the consumable supply replacement-related information comprising information on at least one of a consumable supply to be replaced and a replacement cycle, and the malfunction-related information comprising information on at least one of a malfunction code and a malfunction description.

24. The method of claim 23, wherein in response to receiving the vehicle event information corresponding to the fueling-related information, providing expense information and fuel price information via a webpage according to the fueling event, a fuel station located within a determined distance of the vehicle, and the fuel amount verified from fuel station information corresponding to the fuel station, and
wherein the providing comprises providing a vehicle book keeping service to the communication terminal based on the expense information.
